(19) United States
(12) Patent Application Publication
(10) Pub. No.: US 2007/0210046 A1
(43) Pub. Date: Sep. 13, 2007

(54) Roller adjusting device of optical laser-lens seat

(76) Inventor: Jin-Sheng Lai, Hsih Chih City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/368,392

(22) Filed: Mar. 7, 2006

(51) Int. Cl. B23K 26/08

(52) U.S. Cl. 219/121.78

(57) ABSTRACT

A roller adjusting device of an optical laser-lens seat, the roller adjusting device is used on a laser-engraving machine for adjusting rollers in order that the rollers slide stably on guiding rails. The roller adjusting device includes a sheet member, and is provided on two ends of the sheet member each with a notch, each of the notches is formed at its two lateral sides pressing areas, each of the pressing areas is provided with a tightening means. When the sheet member is horizontally fixed on a spring leaf clamping the rollers, the tightening means are adjusted to press downwardly the spring leaf and the rollers thus cling more tight to the guiding rails.

### BACKGROUND OF THE INVENTION

1. Field of the Invention

The present invention relates to a roller adjusting device of an optical laser-lens seat, and more particularly to a roller adjusting device of an optical laser-lens seat for increasing the stability and accuracy of rollers on guiding rails. The device is structurally simple, convenient for assembling as well as adjusting. It is suitable for applying to an optical laser-lens seat of a processing equipment of a laser-engraving machine.

2. Description of the Prior Art

Drawing machines, printing machines and laser-engraving machines are similar in having printing heads (engraving heads) mounting on rails, by moving right and left of the printing heads (engraving heads) and moving frontwards and backwards of papers (articles engraved), data (drawings) can be printed (engraved) on the papers (articles engraved).

A conventional laser-engraving machine takes advantage of a lens of an optical laser-lens seat mounted on guiding rails, in order that laser light is projected by lens reflecting. The optical laser-lens seat has rollers in order that the optical laser-lens seat can move to and fro on the guiding rails, so that the laser light is projected by lens reflecting in different angles.

However, referring to FIG. 1, rollers B on an optical laser-lens seat A are clamped by a spring leaf C; the spring leaf C is locked on the optical laser-lens seat A. When the rollers B move to and fro on guiding rails D for a long time, the surfaces of the rollers B must have damage induced by abrading and have gaps. The stability and accuracy of the rollers B on guiding rails D will be affected if the rollers B are not changed, and thereby the quality and superiority of the machine products must be affected too.

In view of this, a user will change all the spring leaf and the rollers clamped after using a period of time or based on experiences. But the timing for rollers changing is hard to decide because it costs high and generates waste material, more importantly, it also affects the quality and superiority of the machine products.

### SUMMARY OF THE INVENTION

The primary objective of the present invention is to provide a roller adjusting device of an optical laser-lens seat, the device is structurally simple; it can increase the stability and accuracy of rollers on guiding rails.

To achieve the above objective, the roller adjusting device of the optical laser-lens seat of the present invention is used on a laser-engraving machine for roller adjusting, in order that the rollers can slide stably on the guiding rails. The roller adjusting device includes a sheet member. The sheet member is provided on its two ends each with a notch, each notch is formed at its two lateral sides pressing areas and each of the pressing areas is provided with a tightening means. When the sheet member is horizontally fixed on a spring leaf clamping the rollers, the tightening means are adjusted to press downwardly the spring leaf, the rollers can thus cling more tight to the guiding rails.

The present invention will be apparent in its content of construction and the effect to be achieved after reading the detailed description of the preferred embodiment thereof in reference to the accompanying drawings.

### BRIEF DESCRIPTION OF THE DRAWINGS

FIG. 1 is a perspective view showing the appearance of a conventional laser-engraving machine after rollers on a laser-lens seat are combined with guiding rails;

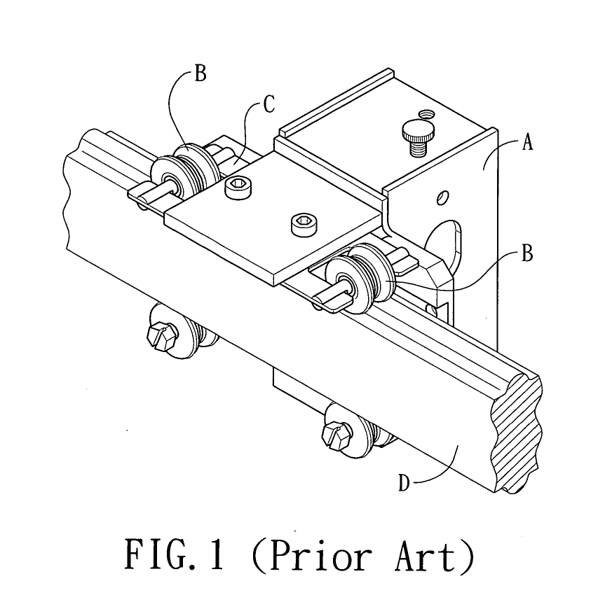

FIG. 2 is an exploded perspective view showing the appearance in the state being the roller adjusting device of the embodiment of the present invention combined with the laser-lens seat and the spring leaf;

FIG. 3 is a schematic view showing the appearance in the state after the roller adjusting device of the embodiment of the present invention combined with the optical laser-lens seat and the spring leaf;

FIG. 4 is a perspective view showing the appearance in the state after the roller adjusting device of the embodiment of the present invention combined with the optical laser-lens seat, the spring leaf and guiding rails;

FIG. 5 is a partially enlarged schematic perspective view showing the appearance in the state after the roller adjusting device of the embodiment of the present invention combined with the optical laser-lens seat, the spring leaf and guiding rails; and

FIG. 6 is a schematic view showing the state of using of the roller adjusting device of the embodiment of the present invention.

### DETAILED DESCRIPTION OF THE PREFERRED EMBODIMENT

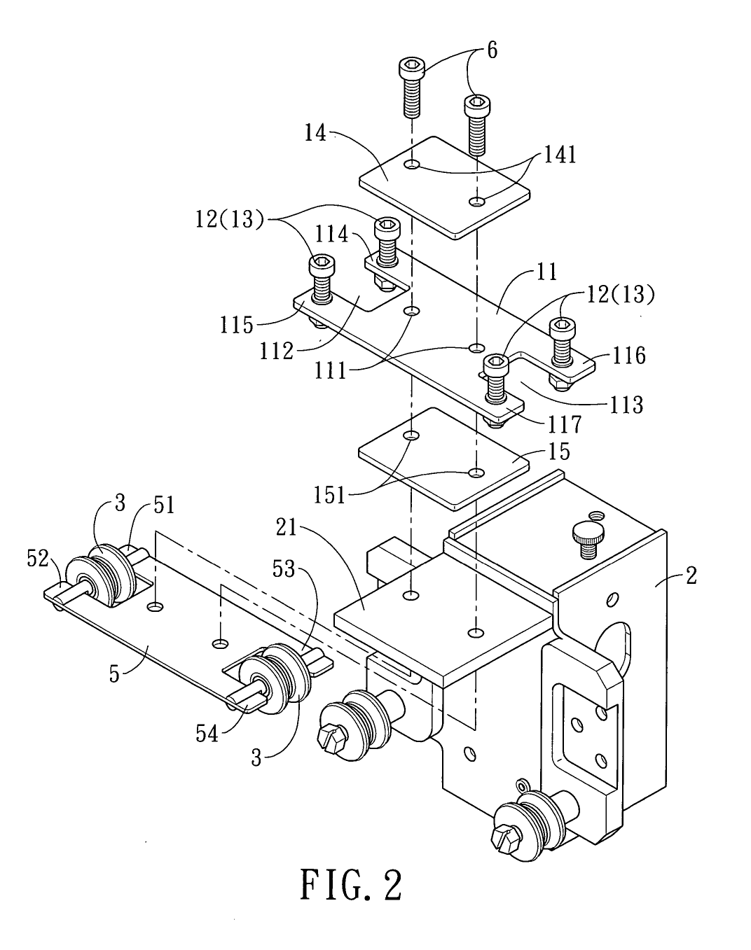

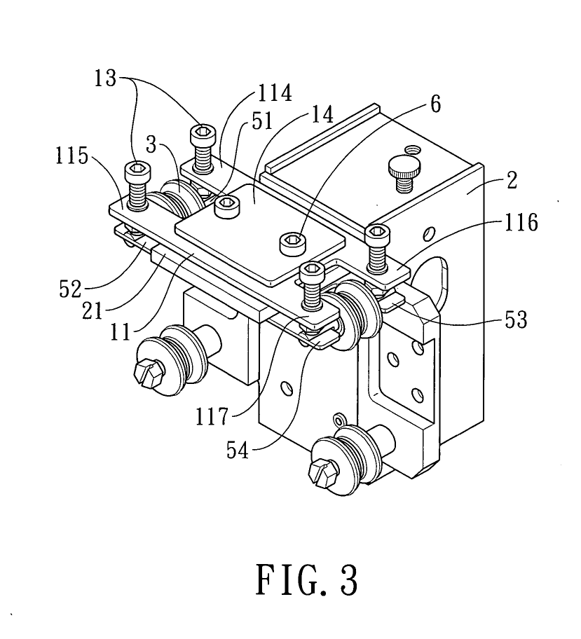

Referring firstly to FIGS. 2, 3 showing an embodiment of roller adjusting device 1 of an optical laser-lens seat 2 of the present invention. The roller adjusting device 1 is used on the optical laser-lens seat 2 for adjusting rollers 3 to make them slide stably on guiding rails 4.

The roller adjusting device 1 includes a sheet member 11 having locking holes 111 thereon; the sheet member 11 can be fixedly locked on a spring leaf 5 clamping the rollers 3. The sheet member 11 is provided on its two ends each with a notch 112, 113, the notches 112, 113 are formed at their lateral sides pressing areas 114-117 respectively. Each of the pressing areas 114-117 is provided with a tightening means 12. In this embodiment, the tightening means 12 can be a locking member 13 such as a set of screw and nut. The roller adjusting device 1 further includes a pair of separating sheets 14, 15; the separating sheets 14, 15 are provided with holes 141, 151 aligned mutually. The sheet member 11 sandwiched in the separating sheets 14, 15 can be locked fixedly together with the spring leaf 5 clamping the rollers 3.

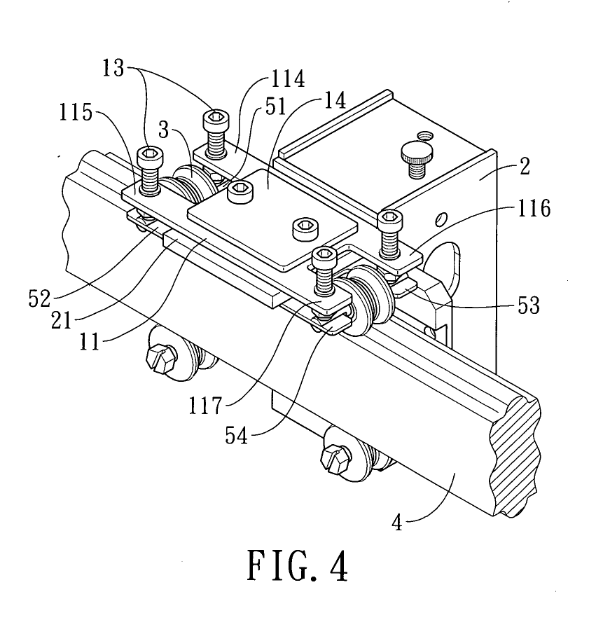

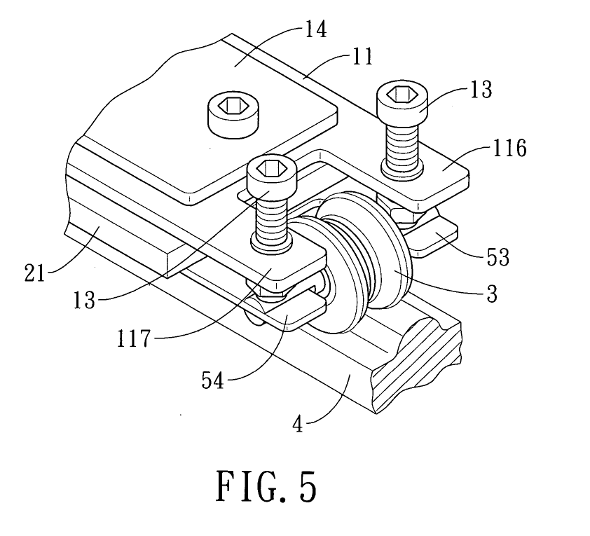

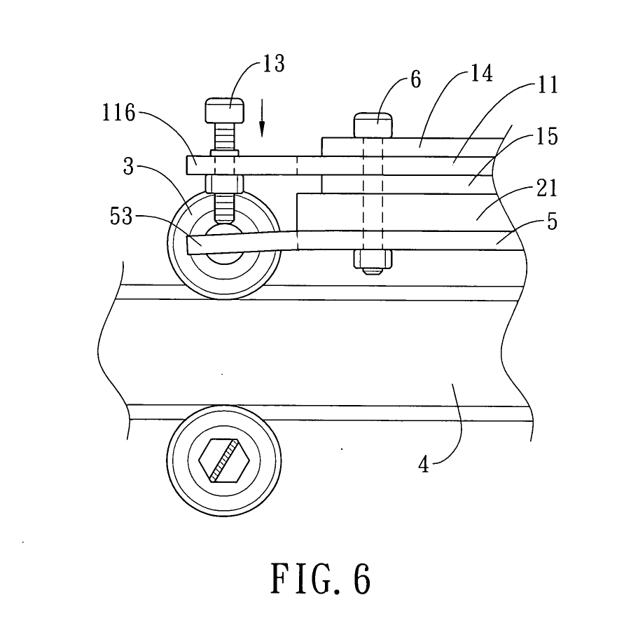

In practicing, referring to FIGS. 2-6, firstly placing the sheet member 11 therebetween the separating sheets 14, 15 and having the holes 141, 151 of the separating sheets 14, 15 align with the holes 111 of the sheet member 11. Further having two screws 6 extending through these holes 141, 151 to lock fixedly the spring leaf 5 clamping the rollers 3 on a fixing plate 21 of the optical laser-lens seat 2, so that the two separating sheets 14, 15 and the sheet member 11 are fixedly locked on the spring leaf 5 clamping the rollers 3, and the notch 112, 113 provided on the two ends of the sheet member 11 can exactly be located at where the rollers 3 are, while the pressing areas 114-117 formed at the lateral sides of the notches 112, 113 are also located at where roller clamping areas 51-54 on the two ends of the spring leaf 5 are.

Therefore, when the rollers 3 on the optical laser-lens seat 2 move to and fro on the guiding rails 4 for a long time to have gaps, a user can adjust the locking members 13 on the pressing areas 114-117 on the two ends of the sheet member 11 to render the locking members 13 to press the roller clamping areas 51-54 on the two ends of the spring leaf 5. Thereby the roller clamping areas 51-54 are forced to bend down, and the rollers 3 clamped by the roller clamping areas 51-54 cling more tight to the guiding rails 4.

Accordingly, the present invention has the following advantages:
1. When the rollers move to and fro on the guiding rails for a long time to have gaps, a user can adjust the rollers with the roller adjusting device of the present invention, in order that the rollers cling more tight to the guiding rails to increase the stability and accuracy of the rollers on the guiding rail. There is no necessity to change the whole set of the spring leaf and the rollers. And cost and waste material generated can be reduced.
2. The roller adjusting device of the present invention can adjust at any time by means of common simple locking members (such as screws) after the rollers are pressed tight with the spring leaf. The device is structurally simple, and convenient for assembling as well as adjusting.

In conclusion, according to the specification and drawings disclosed above, the present invention surely can achieve the expected objective thereof to provide a roller adjusting device which is structurally simple, and convenient for assembling as well as adjusting.

The preferred embodiment is only for illustrating the technical measures used for the present invention. It will be apparent to those skilled in this art that various equivalent modifications or changes can be made to the elements of the present invention without departing from the spirit and scope of this invention. Accordingly, all such modifications and changes also fall within the scope of the appended claims and are intended to form part of this invention.

1. A roller adjusting device of an optical laser-lens seat, said roller adjusting device is used on a laser-engraving machine for adjusting rollers in order that said rollers slide stably on guiding rails, said roller adjusting device includes a sheet member, and is provided on two ends of said sheet member each with a notch, each of said notches is formed at its two lateral sides pressing areas, each of said pressing areas is provided with a tightening means; when said sheet member is horizontally fixed on a spring leaf clamping said rollers, said tightening means are adjusted to press downwardly said spring leaf, said rollers thus cling more tight to said guiding rails.

2. The roller adjusting device of an optical laser-lens seat as claimed in claim 1, wherein: said sheet member has locking holes thereon, and is fixedly locked on said spring leaf clamping said rollers with screws.

3. The roller adjusting device of an optical laser-lens seat as claimed in claim 1, wherein: said pressing areas are respectively provided with locking members that form said tightening means.

4. The roller adjusting device of an optical laser-lens seat as claimed in claim 3, wherein: said locking members are screws and nuts.

5. The roller adjusting device of an optical laser-lens seat as claimed in claim 1, wherein: said roller adjusting device further includes a pair of separating sheets, said separating sheets are provided thereon with holes aligned mutually; said separating sheets are locked together with said spring leaf clamping the rollers with screws after they are placed on an upper and a lower surface of said sheet member.
